(19) United States
(12) Patent Application Publication
(10) Pub. No.: US 2013/0056142 A1
(43) Pub. Date: Mar. 7, 2013

(54) DECORATIVE DECAL FOR RECESSED LIGHT TRIM

(71) Applicants: Joseph W. Fiore, Long Beach, NY (US); Christopher O'Donnell, Melville, NY (US)

(72) Inventors: Joseph W. Fiore, Long Beach, NY (US); Christopher O'Donnell, Melville, NY (US)

(21) Appl. No.: 13/602,740

(22) Filed: Sep. 4, 2012

Related U.S. Application Data
(60) Provisional application No. 61/573,232, filed on Sep. 2, 2011.

(51) Int. Cl. B32B 38/10; B32B 33/00; F21V 21/00; B32B 7/12

(52) U.S. Cl. 156/249; 428/41.8; 362/249.01

(57) ABSTRACT

A decorative decal assembly for application to a trim of a recessed light assembly having a planar, generally ring-shaped decal which has an outer peripheral edge and an inner peripheral edge, a front surface and an opposite rear surface. The rear surface has an adhesive for adhering the decal to the trim of the recessed lighting. The assembly also including a planar release strip, removably attached to the rear surface of the decal via the adhesive. The release strip is removable from the decal, to permit the rear surface of the decal to be affixed to the trim of the recessed light assembly via the adhesive.

### CROSS-REFERENCE TO RELATED APPLICATION

This application claims benefit from U.S. Provisional Patent Application No. 61/573,232, filed Sep. 2, 2011, the contents of which are hereby incorporated by reference.

### BACKGROUND OF THE INVENTION

1. Field of the Invention

The invention is generally in the field of lighting. More particularly, the present invention is directed to a decorative decal for application to a trim of a recessed light assembly and a method of application of the decorative decal to the trim of the recessed light assembly.

2. Brief Description of the Prior Art

Recessed lights also known as high hat lights are well known in the art. Typically, a recessed light assembly includes a lighting unit which is positioned within a ceiling so that the light emitted therefrom shines vertically downwardly. The lightbulb of the recessed light assembly is often times received within a casing having a trim around the periphery thereof. The casing is recessed into the ceiling with the trim lying flush against the ceiling around the periphery of the casing, for a more aesthetic appearance.

While there are many different kinds of finishes and colors for walls or ceilings such as, for example, patterned wall paper, faux finishes or painted walls or ceilings, there is a lack of variety on trims for recessed lights. Typically, the trim of the recessed light assembly is a white color. Therefore, there are little options available to customize or alter the appearance of the trims of the recessed light assemblies. So far as is known, the prior art does not resolve this deficiency in a simple, effective and highly advantageous manner, as in the present invention.

### SUMMARY OF THE INVENTION

It is therefore an object of the present invention to provide a novel decorative decal assembly which is applicable to a recessed light trim, a recessed light kit, and a method of application of a decorative decal to the trim of a recessed light assembly.

It is another object of the invention to provide a decorative decal assembly which changes the appearance of the recessed light trim.

It is yet another object of the invention to provide a decorative decal assembly which allows the user to coordinate or match the recessed light trim to their decor.

It is also an object of the present invention to provide a decorative decal assembly which is quick and easy to install on to a recessed light trim.

It is a further object of the invention to provide a decorative decal which is easily removable.

It is another object of the invention to provide a decorative decal assembly which is less expensive and easy to manufacture.

Certain of the foregoing and related objects are readily attained according to the present invention by the provision of a decorative decal assembly for application to a trim of a recessed light assembly, comprising a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and a planar release strip, removably attached to said rear surface of said decal via said means for adhering, and wherein said release strip is removable from said decal, to permit said rear surface of said decal to be affixed to the trim of the recessed light assembly via said means for adhering.

In the preferred embodiment, said decal has a circular-shaped outer peripheral edge and a circular-shaped inner peripheral edge and said circular-shaped outer peripheral edge has a diameter which is in the range of about 2 inches to about 8 inches. It is also preferred that said means for adhering said decal to the trim of the recessed lighting is an adhesive. Furthermore, it is desirable that the assembly further comprises a tab disposed between said decal and said release strip to assist in removal of said release strip from said decal.

In addition, in the preferred embodiment, said front surface of said decal is imprinted with indicia and said indicia is a member selected from the group consisting of colors, patterns, and textures. Desirably, said decal is made of a polyvinyl material and has a thickness of about 2 millimeters.

Certain of the foregoing and related objects are readily attained according to the present invention by the provision of a method of application of a decorative decal assembly to a trim of a recessed light assembly, comprising the steps of providing a recessed light assembly having a trim and a decorative decal assembly for application to said trim of said recessed light assembly, comprising a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and a planar release strip, removably attached to said rear surface of said decal via said means for adhering, and wherein said release strip is removable from said decal, to permit said rear surface of said decal to be affixed to the trim of the recessed light assembly via said means for adhering; removing said release strip from said decal; aligning said decal with said trim of said recessed light assembly; and affixing said rear surface of said decal to said trim of said recessed light assembly via said means for adhering.

In the preferred embodiment, said decal has a circular-shaped outer peripheral edge and a circular-shaped inner peripheral edge and said circular-shaped outer peripheral edge has a diameter which is in the range of about 2 inches to about 8 inches. In addition, it is preferred that said means for adhering said decal to said trim of said recessed lighting is an adhesive.

Additionally in the preferred embodiment, the method further comprises the steps of providing a tab disposed between said decal and said release strip; and grasping said tab to remove said release strip from said decal. It is also preferable that said front surface of said decal is imprinted with indicia and said indicia is a member selected from the group consisting of colors, patterns, and textures. Desirably, said decal is made of a polyvinyl material and has a thickness of about 2 millimeters.

Moreover, certain of the foregoing and related objects are readily attained according to the present invention by the provision of a kit for applying a decorative decal assembly to a trim of a recessed light assembly, comprising at least one recessed light assembly having a trim; and at least one decorative decal assembly for application to said trim of said recessed light assembly, comprising a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and a planar release strip, removably attached to said rear surface of said decal via said means for adhering, and wherein said release strip is removable from said decal, to permit said rear surface of said decal to be affixed to the trim of the recessed light assembly via said means for adhering.

Advantageously, said decal is removably affixable to said trim of said recessed light assemblies.

### BRIEF DESCRIPTION OF THE DRAWINGS

Other objects and features of the present invention will become apparent from the detailed description considered in connection with the accompanying drawings, which disclose several embodiments of the invention. It is to be understood that the drawings are to be used for the purpose of illustration only and not as a definition of the limits of the invention.

FIG. 1 is a perspective view of a decorative decal, according to the present invention, applied to the trim of a recessed light assembly, which is mounted in a ceiling;

FIG. 2 is a top plan view of the decorative decal assembly;

FIG. 3 is a perspective view of the casing and trim of the recessed light assembly being removed from the ceiling;

FIG. 4 is a perspective view of the trim being removed from the casing;

FIG. 5 is a perspective view of the release strip being removed from the decal;

FIG. 6 is a perspective view of the decal being aligned with the trim; and

FIG. 7 is a perspective view of the decal being affixed to the trim.

### DETAILED DESCRIPTION OF THE PREFERRED EMBODIMENTS

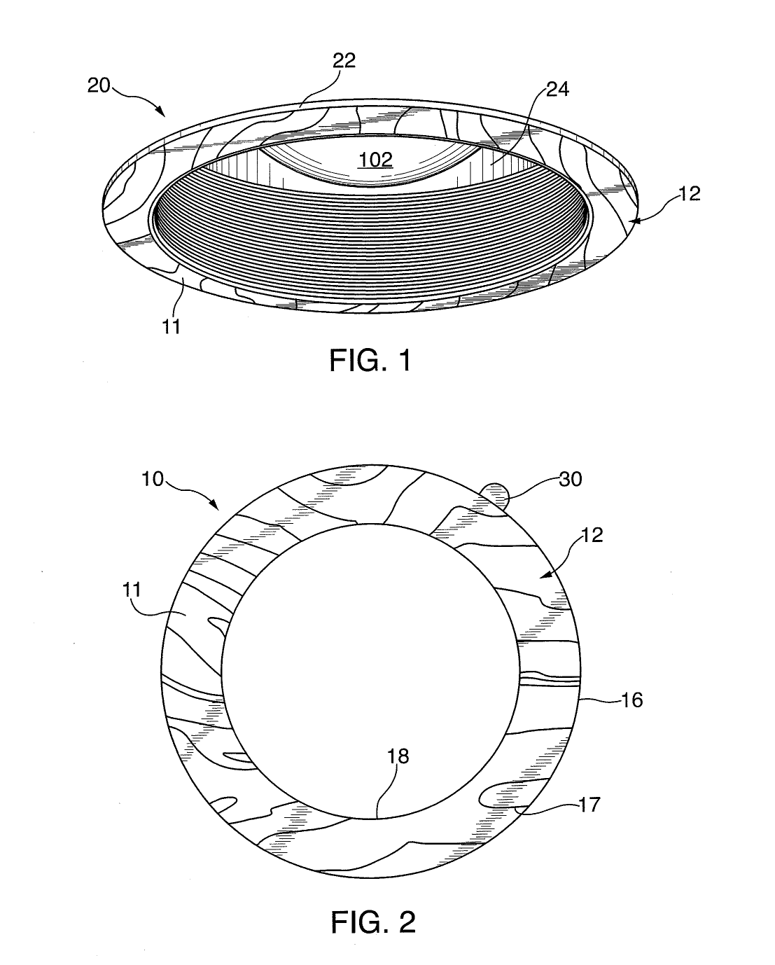

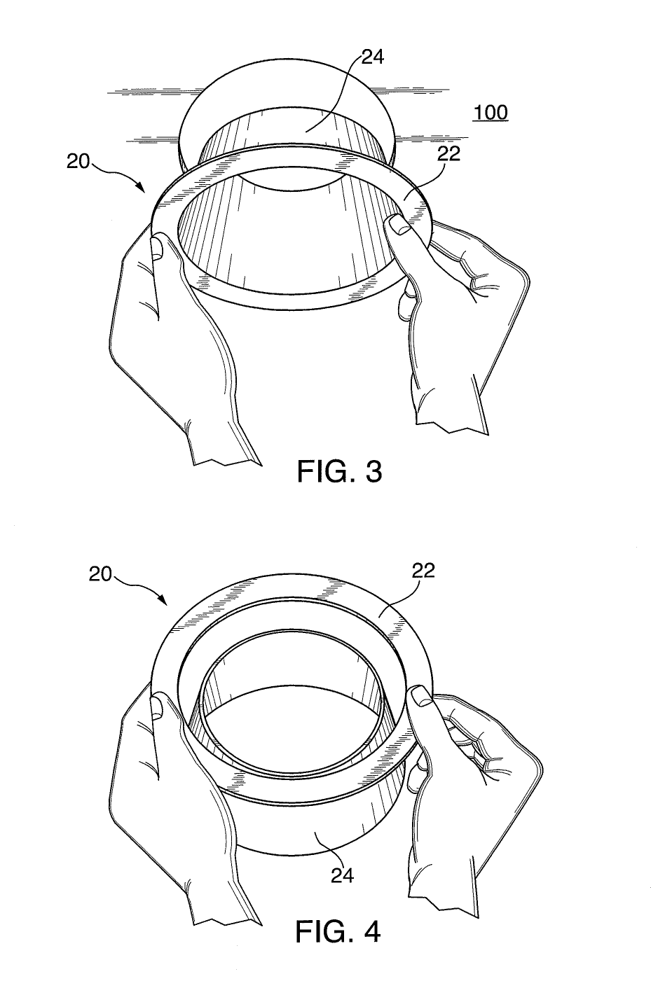

Turning now in detail to the drawings and in particular FIG. 1, which illustrates the decorative decal, generally designated by reference numeral 12, according to the present invention, after installation on a conventional recessed light assembly, generally designated by reference numeral 20. Particularly, recessed light assembly 20 includes a light bulb 102, housed within a conventional casing 24 which is recessed into a ceiling 100 (see, FIG. 3), and a trim 22 disposed around the periphery of the casing 24 and flush against the ceiling 100, when installed. The decorative decal 12 is applied to trim 22 to alter its appearance to provide for a more aesthetic appearance and/or coordinate or match the decor, as is desired.

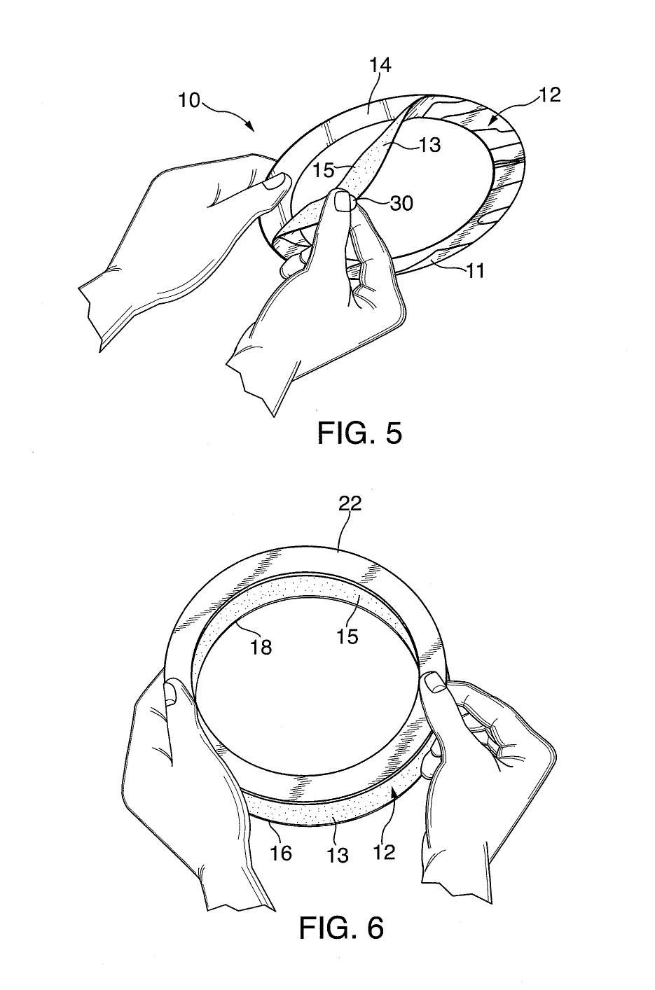

In particular, as seen in FIGS. 2 and 5, decorative decal assembly, generally designated by reference numeral 10 includes decal 12 and a removable release strip 14 (see FIG. 5). Decal 12 is affixable to trim 22 of recessed light assembly 20 to alter its appearance as shown best in FIG. 1. As seen in FIG. 2, decal 12 is planar and generally ring-shaped and has a size and a shape which generally corresponds to the size and the shape of the trim 22 of the recessed light assembly 20, so that decal 12 can be applied to trim 22 to cover the exposed surface of trim 22.

As also seen in FIG. 2, decal 12 includes an outer peripheral edge 16, an inner peripheral edge 18, a front surface 11 and an opposite rear surface 13 (see, FIG. 6). Preferably, the outer peripheral edge 16 and the inner peripheral edge 18 are circular-shaped, to correspond to the shape of trim 22. However, it can be appreciated that the shape of either or both of the outer and inner peripheral edges 16, 18, respectively, can be modified to have a different shape such as, for example, square, rectangular, triangular, diamond-shaped, oval, floral-shaped and/or star-shaped. As used herein, the term ring-shaped encompasses the various shapes of the decal mentioned previously and any other shape formed by the inner and outer peripheral edges. Preferably, decal 12 is made of a polyvinyl material and has a thickness of approximately 0.01 inches or higher, with a preferred thickness of about 2 millimeters. However, other suitable materials can be utilized such as, vinyl or paper. It is also preferable that the decal 12 has a diameter which corresponds to the size of the trim 22 and can be manufactured in a number of standard dimensions, such as, for example, 2″, 3″, 4″, 5″, 6″ and 8.″ However, the decal 12 can assume any number of dimensions.

As shown in FIG. 2, front surface 11 of decal 12 is imprinted with indicia 17, to alter and modify the appearance of trim 22, when applied. The indicia 17 can include various colors, patterns, designs, and/or textures. It can be appreciated that there can be any variety of indicia imprinted on decal 12.

As seen best in FIG. 5, rear surface 13 includes means for adhering decal 12 to trim 22 of the recessed light assembly 20, preferably via an adhesive layer 15. However, other means for adhering decal 12 to trim 22 can be utilized such as, for example, a self-adhering material or magnetism. In one embodiment, decal 12 is easily removable from trim 22 to readily change decals 12 or remove the decals 12.

Additionally, as seen best in FIG. 5, decorative decal assembly 10 also includes a planar release strip 14, which is removably attached to the rear surface 13 of decal 12. Particularly, release strip 14 is removably attached to decal 12 via the adhesive layer 15 and covers the adhesive layer 15 until decal 12 is to be applied to trim 22. Preferably, the release strip 14 is made of a material to allow for decal 12 to be easily removed therefrom.

To assist in separating decal 12 from release strip 14, a tab 30 can be provided, as shown in FIGS. 2 and 5. Preferably, tab 30 is disposed between decal 12 and release strip 14 and projects outwardly beyond outer peripheral edge 16, to assist in removal of release strip 14 from decal 12. However, other means to assist in separation of decal 12 from release strip 14 can be utilized such as, for example, an outwardly projecting tab formed on release strip 14. Preferably, release strip 14 has a size and a shape which generally corresponds to the size and shape of decal 12, however, other sizes and shapes can be utilized.

In order to apply decal 12 to trim 22, casing 24 and trim 22 are removed from ceiling 100 together with lightbulb 102, if the recessed light assembly 20 is already installed in a ceiling, as seen in FIG. 3. Next, as seen in FIG. 4, trim 22 is removed from casing 24, if necessary. As seen in FIG. 5, release strip 14 is removed from decal 12 by peeling decal 12 from release strip 14. Optionally, the user can grasp tab 30 to assist in removing release strip 14 from decal 12.

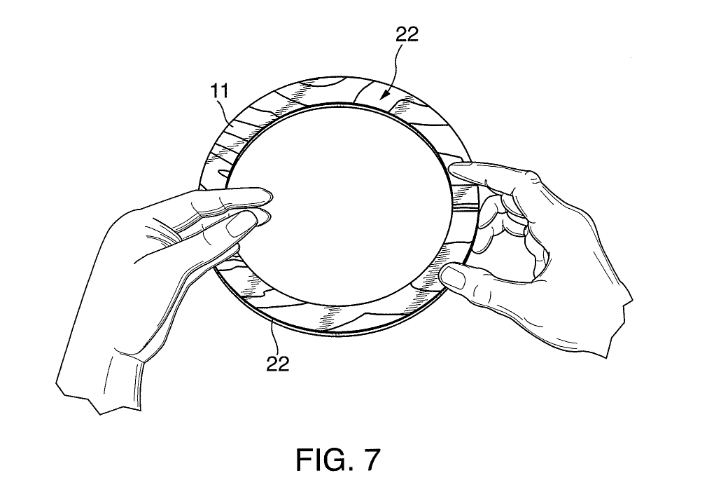

As seen in FIG. 6, it is preferable to place decal 12 on a flat surface with the rear surface 13 facing up. As also seen in FIG. 6, trim 22 is aligned with decal 12 so that decal 12 covers trim 22. As seen in FIG. 7, trim 22 is placed on top of rear surface 13 of decal 12 so that adhesive 15 adheres decal 12 to trim 22. Casing 24 and trim 22 as well as light bulb 102 are returned to ceiling 100, with the front surface 11 of decal 12 visible.

In another embodiment of the present invention, the decal 12 can be applied directly to ceiling 100 beneath trim 22, to alter the appearance of the ceiling around the periphery of recessed light assembly 20. In this embodiment, the decal 12 has a diameter which is larger than the diameter of trim 22, so that decal 12, once installed, can be seen projecting outwardly from recessed light assembly 20. For example, decal 12 can assume the shape of a star or flower to decorate the ceiling 100 around the recessed light assembly 20. However, it can be appreciated that the decal 12 can assume any shape, as is desired. In order to install the decal 12, the trim 22 and/or casing 24 are removed from ceiling 100, if necessary. Decal 12 is applied to ceiling 100 around the opening in the ceiling 100. Next, casing 24 and/or trim 22 are returned to ceiling 100, so that decal 12 is seen projecting outwardly therefrom on ceiling 100.

While particular embodiments of the invention have been described, it is not intended that the invention be limited thereto, as it is intended that the invention be as broad in scope as the prior art will allow and that the specification be read likewise. It will therefore be appreciated by those skilled in the art that other modifications could be made thereto without departing from the spirit and scope of the invention.

What is claimed is:

1. A decorative decal assembly for application to a trim of a recessed light assembly, comprising:
a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and
a planar release strip, removably attached to said rear surface of said decal via said means for adhering, and wherein said release strip is removable from said decal, to permit said rear surface of said decal to be affixed to the trim of the recessed light assembly via said means for adhering.

2. The assembly according to claim 1, wherein:
said decal has a circular-shaped outer peripheral edge and a circular-shaped inner peripheral edge.

3. The assembly according to claim 1, wherein:
said means for adhering said decal to the trim of the recessed lighting is an adhesive.

4. The assembly according to claim 1, further comprising:
a tab disposed between said decal and said release strip to assist in removal of said release strip from said decal.

5. The assembly according to claim 1, wherein:
said front surface of said decal is imprinted with indicia.

6. The assembly according to claim 5, wherein:
said indicia is a member selected from the group consisting of colors, patterns, and textures.

7. The assembly according to claim 1, wherein:
said decal is made of a polyvinyl material.

8. The assembly according to claim 1, wherein:
said decal has a thickness of about 2 millimeters.

9. The assembly according to claim 2, wherein:
said circular-shaped outer peripheral edge has a diameter which is in the range of about 2 inches to about 8 inches.

10. A method of application of a decorative decal assembly to a trim of a recessed light assembly, comprising the steps of:
providing a recessed light assembly having a trim and a decorative decal assembly for application to said trim of said recessed light assembly, comprising a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and a planar release strip, removably attached to said rear surface of said decal via said means for adhering, and wherein said release strip is removable from said decal, to permit said rear surface of said decal to be affixed to the trim of the recessed light assembly via said means for adhering;
removing said release strip from said decal;
aligning said decal with said trim of said recessed light assembly; and
affixing said rear surface of said decal to said trim of said recessed light assembly via said means for adhering.

11. The method according to claim 10, wherein:
said decal has a circular-shaped outer peripheral edge and a circular-shaped inner peripheral edge.

12. The method according to claim 10, wherein:
said means for adhering said decal to said trim of said recessed lighting is an adhesive.

13. The method according to claim 10, further comprising the steps of:
providing a tab disposed between said decal and said release strip; and
grasping said tab to remove said release strip from said decal.

14. The method according to claim 10, wherein:
said front surface of said decal is imprinted with indicia.

15. The method according to claim 14, wherein:
said indicia is a member selected from the group consisting of colors, patterns, and textures.

16. The method according to claim 10, wherein:
said decal is made of a polyvinyl material.

17. The method according to claim 10, wherein:
said decal has a thickness of about 2 millimeters.

18. The method according to claim 11, wherein:
said circular-shaped outer peripheral edge has a diameter which is in the range of about 2 inches to about 8 inches.

19. A kit for applying a decorative decal assembly to a trim of a recessed light assembly, comprising:
at least one recessed light assembly having a trim; and
at least one decorative decal assembly for application to said trim of said recessed light assembly, comprising a planar, generally ring-shaped decal which has an outer peripheral edge and an inner peripheral edge, a front surface and an opposite rear surface, said rear surface having means for adhering said decal to the trim of the recessed lighting and wherein said decal has a size and a shape which generally corresponds to a size and a shape of the trim of the recessed light assembly; and a planar release strip, removably attached to said rear surface of said decal via said means for adhering, and wherein said release strip is removable from said decal, to permit said rear surface of said decal to be affixed to the trim of the recessed light assembly via said means for adhering.

20. The kit according to claim 21, wherein:
said decal is removably affixable to said trim of said recessed light assemblies.
